(19) United States
(12) Patent Application Publication
(10) Pub. No.: US 2012/0169915 A1
(43) Pub. Date: Jul. 5, 2012

(54) Image Capturing Apparatus and Electronic Apparatus

(75) Inventor: Jui-Hsiung Kuo, Kaohsiung City (TW)

(73) Assignee: ALTEK CORPORATION, Hsinchu (TW)

(21) Appl. No.: 13/111,526

(22) Filed: May 19, 2011

(30) Foreign Application Priority Data
Dec. 30, 2010 (TW) 099146996

(51) Int. Cl. H04N 5/225

(52) U.S. Cl. 348/335; 348/E05.024

(57) ABSTRACT

An image capturing apparatus and an electronic apparatus are described. The image capturing apparatus comprises a body, a flash lamp, a lens and a fill lamp. The flash lamp is disposed on the body and emits a flash light, and the lens is also disposed on the body. The lens collects and provides lights to an image sensing unit disposed inside the body to generate images. The fill lamp is disposed on the lens and electronically connects to the body. The fill lamp further locates on the direction of the flash lamp facing the lens, and thus provides lights as a filled light when the lens shields the light emitted by the flash lamp.

### FIELD

The exemplary embodiment(s) of the present invention relates to a field of an image capturing apparatus and an electronic apparatus. More specifically, the exemplary embodiment(s) of the present invention relates to an image capturing apparatus and an electronic apparatus that could prevent the shadow effect caused by a lens shielding a flash light.

### BACKGROUND

The conventional flash lamp of cameras is usually disposed on the corner of the camera body, and emitting strong flash lights to enhance the brightness of the subject to be shot under low illumination environment. Thus, the subject can be effectively sensed by the image sensing unit to generate images.

However, when the length of a zoom lens or an interchangeable lens is too long to shield the flash light emitted by the conventional flash lamp, it would cause not only the insufficient brightness of the of the subject to be shot but also an extra shadow effect. Therefore, it is urgent to provide an image capturing apparatus having additional emitting light to improve the quality of the images.

### SUMMARY

To solve the problems in the conventional arts, it is a primary object of the present invention to provide an image capturing apparatus and an electronic apparatus to solve the problem that the flash light would be shielded by the over-length lens.

To achieve the above object, an image capturing apparatus according to the present invention is disclosed, which comprises a body, a flash lamp, a lens and a fill lamp. The flash lamp is disposed on the body and emits a flash light, and the lens is also disposed on the body for collecting and providing lights to an image sensing unit disposed inside the body to generate images. The fill lamp is disposed on the lens and electronically connects to the body. The fill lamp is further located along the direction of the flash lamp facing the lens, and emits lights as a filled light when the flash light is shielded by the lens.

Wherein the lens is a zoom lens.

Wherein the lens is an interchangeable lens.

Wherein the fill lamp emits lights with the flash lamp at the same time.

Wherein the fill lamp emits lights independently when the electronic apparatus is in a recording mode.

To achieve another object, an electronic apparatus according to the present invention is disclosed, which comprises a body, a flash lamp, a lens, a fill lamp, a display module and a control module. The flash lamp is disposed on the body and emits a flash light, and the lens is also disposed on the front-side of the body for collecting and providing lights to an image sensing unit disposed inside the body to generate images. The fill lamp is disposed on the lens and electronically connects to the body. The fill lamp is further located along the direction of the flash lamp facing the lens, and emits lights as a filled light when the flash light is shielded by the lens. The display module is disposed on the backside of the body and displays frames. The control module is disposed inside the body, and electronically connects to and controls the flash lamp, the lens, the fill lamp, the image sensing unit and the display module.

Wherein the electronic apparatus includes cell phone, smart phone, PDA, notebook with recording function or tablet computer with recording function.

Wherein the lens is a zoom lens.

Wherein the lens is an interchangeable lens.

Wherein the control module controls the fill lamp emits lights with the flash lamp at the same time.

Wherein the control module controls the electronic apparatus to emit lights independently when the electronic apparatus is in a recording mode.

With the above arrangements, the image capturing apparatus and the electronic apparatus according to the present invention has one or more of the following advantages:

(1) The recording effect could be increased by disposing a fill lamp on the lens in accordance with the present invention.

(2) The problem of the flash light emitted by the flash lamp being shielded by a lens could be solved by disposing a fill lamp on the lens in accordance with the present invention.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic diagram of the first embodiment of the image capturing apparatus in accordance with the present invention;

FIG. 2 illustrates a schematic diagram of the second embodiment of the image capturing apparatus in accordance with the present invention; and

FIG. 3 illustrates a schematic diagram of the electronic apparatus in accordance with the present invention.

### DETAILED DESCRIPTION

Those of ordinary skill in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

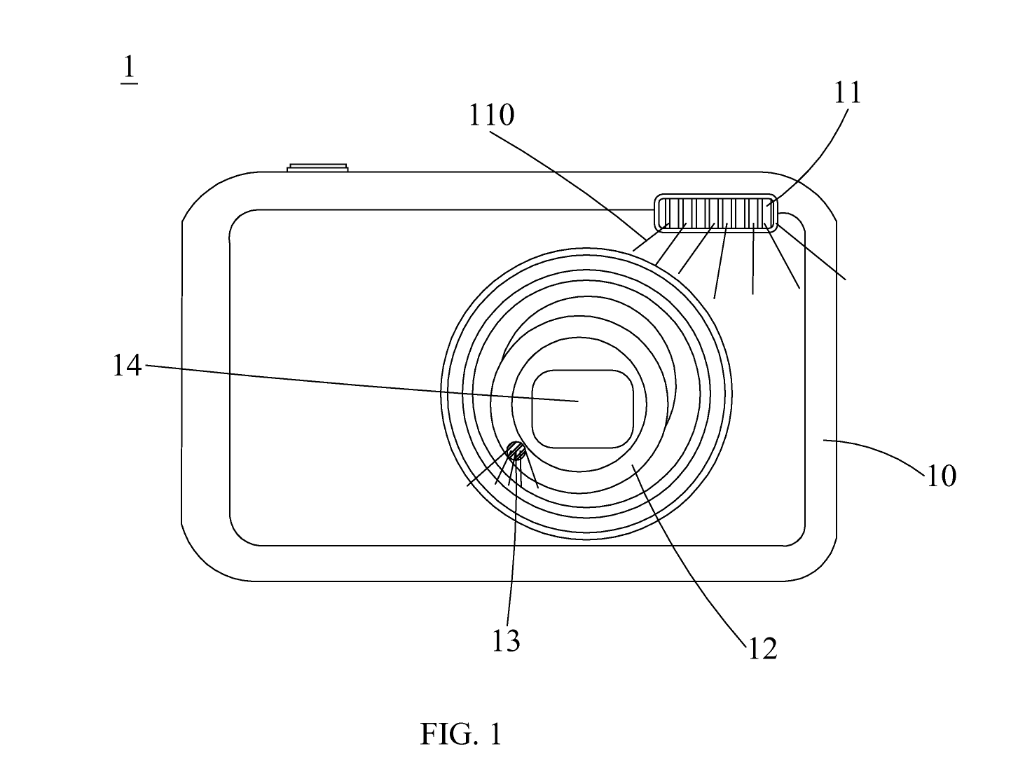

Please refer to FIG. 1, which illustrates a schematic diagram of the first embodiment of the image capturing apparatus in accordance with the present invention. As shown in this figure, the image capturing apparatus 1 in accordance with the present invention comprises a body 10, a flash lamp 11, a lens 12, a fill lamp 13 and an image sensing unit 14. In some preferred embodiments, the image capturing apparatus 1 could be a digital camera or a digital single-lens reflex camera, and the lens 12 could be a zoom lens or an interchangeable lens. The image sensing unit 14 could be a complementary metal-oxide-semiconductor (CMOS) or a charge-coupled-device (CCD). Besides, the fill lamp 13 is preferred to be a high-luminescence light emitting diode (LED), wherein the quantity of the fill lamp is not limited to one.

In the present embodiment, the flash lamp 11 is disposed on the body 10 and emits a flash light 110, and the lens 12 is also disposed on the body 10 for collecting and providing lights to an image sensing unit 14 disposed inside the body 10 to generate images. The fill lamp 13 is disposed on the lens 12 and electronically connects to the body 10. The fill lamp 13 is further located along the direction of the flash lamp 11 facing the lens 12, and emits lights as a filled light when the flash light 110 is shielded by the lens 12.

Besides, the fill lamp 13 emits lights with the flash lamp 11 at the same time in the present embodiment. That is, the fill lamp 13 does not emit lights when focusing and compositing. The image capturing apparatus 1 further determines the quantity of the flash light 110 shielded by the lens 12 according to the length of the lens 12. When a user execute a shutter and the flash lamp, the image capturing apparatus 1 controls the fill lamp 13 to emit light with the quantity which has been determined by the image capturing apparatus 1, so as to eliminate the shadow on the subject generated when the flash light 110 emitted by the flash lamp 11 being shielded by the lens 12.

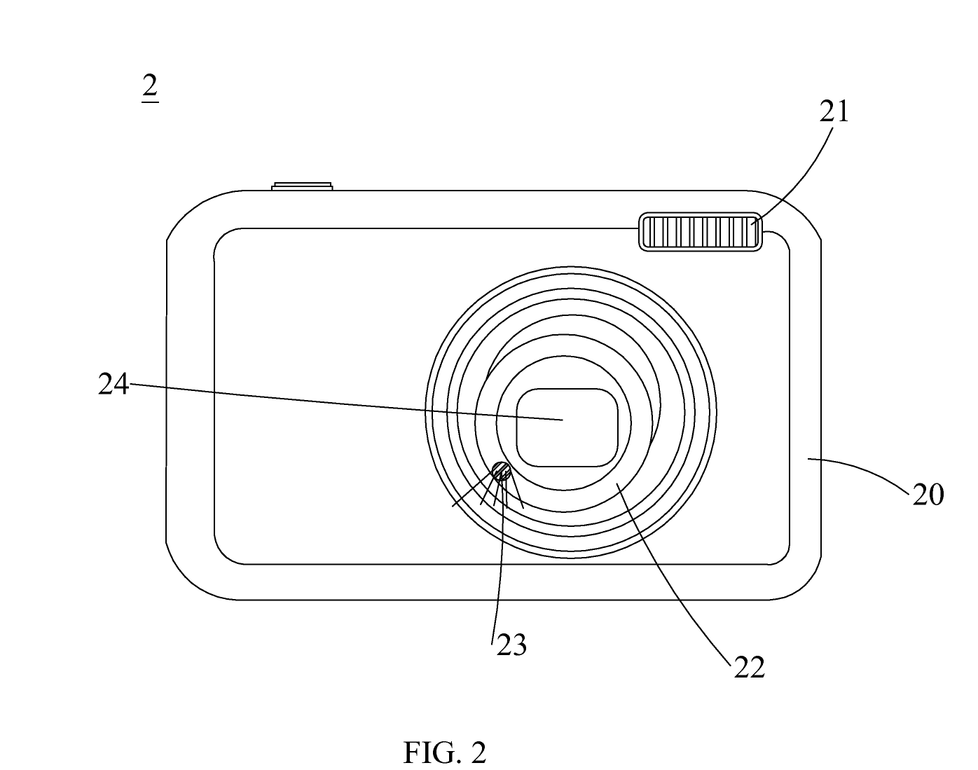

Please refer to the FIG. 2, which illustrates a schematic diagram of the second embodiment of the image capturing apparatus in accordance with the present invention. As shown in this figure, the image capturing apparatus 2 in accordance with the present invention comprises a body 20, a flash lamp 21, a lens 22, a fill lamp 23 and an image sensing unit 24. In some preferred embodiments, the image capturing apparatus 2 could be a digital camera or a digital single-lens reflex camera, and the lens 22 could be a zoom lens or an interchangeable lens. The image sensing unit 24 could be a complementary metal-oxide-semiconductor (CMOS) or a charge-coupled-device (CCD). Besides, the fill lamp 23 is preferred to be a high-luminescence light emitting diode (LED), wherein the quantity of the fill lamp is not limited to one.

In the present embodiment, the flash lamp 21 is disposed on the body 20 and emits a flash light, and the lens 22 is also disposed on the body 20. The lens 22 collects and provides lights to an image sensing unit 24 disposed inside the body to generate images. The fill lamp 23 is disposed on the lens 22 and electronically connects to the body 20. The fill lamp 23 is further located along the direction of the flash lamp 21 facing the lens 22, and emits lights as a filled light.

The most difference between the first embodiment and the second embodiment is that in the first embodiment, the fill lamp 13 emits lights with the flash lamp 11 at the same time to eliminate the shadow on the subject generated when the flash light 110 emitted by the flash lamp 11 being shielded by the lens 12; In the second embodiment, because that the flash lamp 21 cannot emit lights during recording and lose the functional meaning of the flash lamp, the image capturing apparatus 2 controls the fill lamp 23 to emit lights independently and continuously when the image capturing apparatus 2 is in a recording mode to compensate the quantity of light on the subject and to get clear recording record.

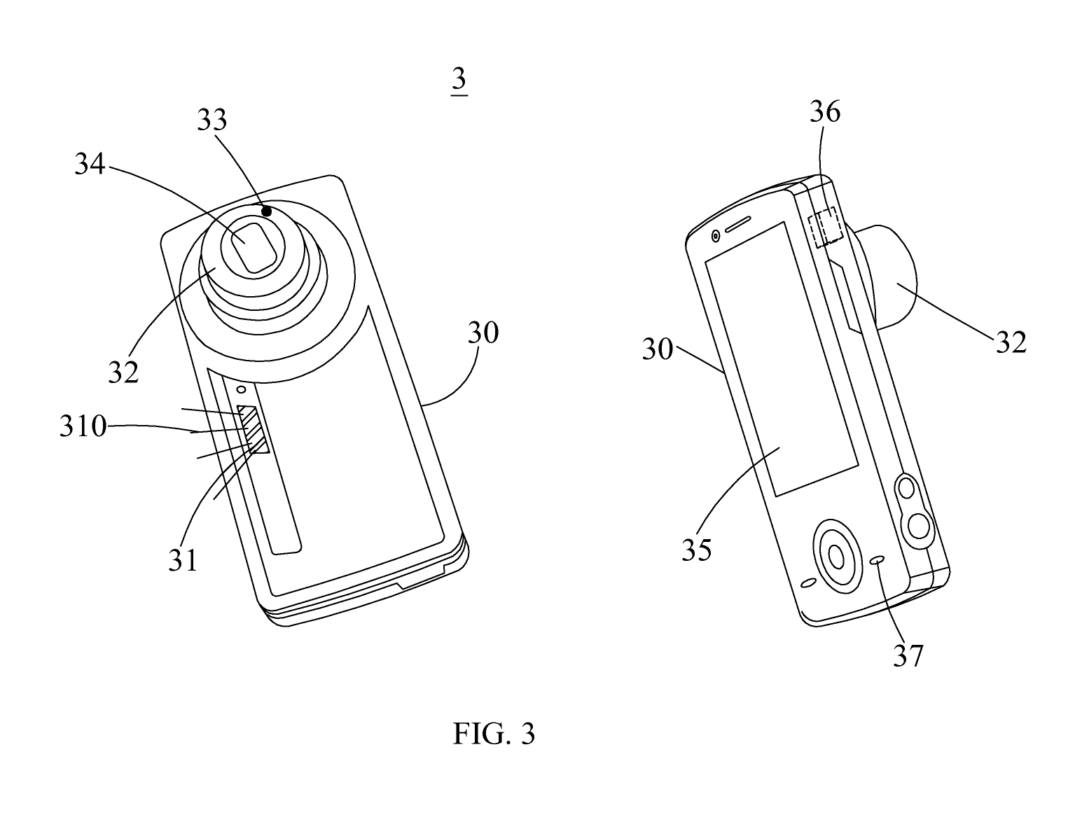

Please refer to FIG. 3, which illustrates a schematic diagram of the first embodiment of the image capturing apparatus in accordance with the present invention. As shown in this figure, the image capturing apparatus 3 in accordance with the present invention comprises a body 30, a flash lamp 31, a lens 32, a fill lamp 33, an image sensing unit 34, a display module 35 and a control module 36. In some preferred embodiments, the lens 32 could be a zoom lens or an interchangeable lens. The image sensing unit 34 could be a complementary metal-oxide-semiconductor (CMOS) or a charge-coupled-device (CCD). Besides, the fill lamp 33 is preferred to be a high-luminescence light emitting diode (LED), wherein the quantity of the fill lamp is not limited to one.

In the present embodiment, the flash lamp 31 is disposed on the front-side of body 30 and emits a flash light 310, and the lens 32 is also disposed on front-side of the body 30. The lens 32 collects and provides lights to an image sensing unit 34 disposed inside the body to generate images. The fill lamp 33 is disposed on the lens 32 and electronically connects to the body 30. The fill lamp 33 is further located along the direction of the flash lamp 31 facing the lens 22, and emits lights as a filled light when the flash light 310 is shielded by the lens 32. The display module 35 disposed on the backside of the body 30 and displays frames and provides touching signals (not showing in this figure) after being a touched. The control module 36 is disposed inside the body 30. The control module 36 electronically connects to the flash lamp 31, the lens 32, the fill lamp 33, the image sensing unit 34 and the display module 35, and controls the devices mentioned above by the touching signals. In some preferred embodiments, the display module could be but not restricted to a resistive touch screen, a capacitive touch screen, an infrared ray touch screen or an ultrasonic wave touch screen. Besides, at least one input module 37 could be disposed on the electronic apparatus 3 so as to let users inputting control commands to control the apparatus 3.

The control module 36 could be a central processing unit or a micro processing unit. The control module 36 controls the fill lamp 33 to emit light with the flash lamp 35 at the same time according to the touching signal received by the display module (i.e. touching screen), or controls the fill light 33 to emit light independently when the electronic apparatus 3 being in a recording mode. The implementation of the image capturing apparatus in accordance with the present invention has already described in the description above, so it will not be stated here again.

What is deserved to be mentioned is that the image capturing apparatus 3 in accordance with the present invention could be but not limit to a cell phone, a smart phone, a personal digital assistant (PDA), a notebook with recording function or a tablet computer with recording function. Those of ordinary skilled in the art could execute some modifications according to the main idea of the present invention.

In summary, the image capturing apparatus and the electronic apparatus in accordance with the present invention could increase the recording effect by disposing the fill lamp on the lens, and further solve the problem that the flash light emitted by the flash lamp being shielded by the lens.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. An image capturing apparatus, comprising:
a body;
a flash lamp, disposed on the body and emitting a flash light;
a lens, disposed on the body, collecting and providing lights to an image sensing unit disposed inside the body to generate images; and
a fill lamp, disposed on the lens and electronically connecting to the body, located along the direction of the flash lamp facing the lens, and emitting lights as a filled light when the flash light is shielded by the lens.

2. The image capturing apparatus of claim 1, wherein the lens is a zoom lens.

3. The image capturing apparatus of claim 1, wherein the lens is an interchangeable lens.

4. The image capturing apparatus of claim 1, wherein the fill lamp emits lights with the flash lamp at the same time.

5. The image capturing apparatus of claim 1, wherein the fill lamp emits lights independently when the image capturing apparatus is in a recording mode.

6. An electronic apparatus, comprising:
a body;
a flash lamp, disposed on the front-side of the body and emitting a flash light;
a lens, disposed on the front-side of the body, collecting and providing lights to an image sensing unit disposed inside the body to generate images;
a fill lamp, disposed on the lens and electronically connecting to the body, located along the direction of the flash lamp facing the lens, and emitting lights as a filled light when the flash light is shielded by the lens;
a display module, disposed on the backside of the body, displaying frames; and
a control module, disposed inside the body, electronically connecting to and controlling the flash lamp, the lens, the fill lamp, the image sensing unit and the display module.

7. The electronic apparatus of claim 6, wherein the electronic apparatus including cell phone, smart phone, PDA, notebook with recording function or tablet computer with recording function.

8. The electronic apparatus of claim 6, wherein the lens is a zoom lens.

9. The electronic apparatus of claim 6, wherein the lens is an interchangeable lens.

10. The electronic apparatus of claim 6, wherein the control module controlling the fill lamp emits lights with the flash lamp at the same time.

11. The electronic apparatus of claim 6, wherein the control module controls the electronic apparatus emitting lights independently when the electronic apparatus is in a recording mode.
